(19) United States
(12) Patent Application Publication
(10) Pub. No.: US 2021/0346822 A1
(43) Pub. Date: Nov. 11, 2021

(54) METHODS AND SYSTEMS FOR RECOVERY OF VALUABLE TARGET SPECIES FROM BRINE SOLUTIONS

(71) Applicant: Prairie Lithium Corporation, Emerald Park (CA)

(72) Inventor: Ian Daniel Ireland, Regina (CA)

(73) Assignee: Prairie Lithium Corporation, Emerald Park (CA)

(21) Appl. No.: 17/313,266

(22) Filed: May 6, 2021

Related U.S. Application Data
(60) Provisional application No. 63/021,498, filed on May 7, 2020.

(51) Int. Cl. B01D 15/36; B01D 15/12; B01D 15/26

(52) U.S. Cl. CPC B01D 15/361; B01D 15/265; B01D 15/125

(57) ABSTRACT

Methods and systems for recovering high-value target ions such as lithium ions from a brine solution, wherein a target-ion-selective adsorbent material (such as bound or unbound adsorbent particles) are mixed with the brine solution to form a slurry, and the slurry is contacted with a filter to capture target-ion-enriched material, which target-ion-enriched material is then contacted with a stripping solution to separate the target ions from the target-ion-enriched material.

### BACKGROUND

### 1. Field

The present disclosure relates to methods for recovery of valuable components or species such as lithium from brine solutions, and more particularly to such methods involving the use of species-selective materials.

### 2. State of the Art

Naturally occurring brines, be they seawater, salar brines, geothermal brines, oilfield brines, or others, consist of a complex mixture of components present across a broad range of concentrations. Some of these components have significant commercial value if they can be isolated from the other species in solution. Lithium is one non-limiting example of such a component or species that is found in brine solutions.

Lithium has a number of different commercial applications, and various technologies have been developed for obtaining lithium for such purposes. It is known in the field that lithium is present in certain surface and subsurface brines, and recovery of lithium from such brines has given rise to numerous production and extraction techniques. One well-known technique involves producing a lithium-bearing brine to surface and contacting it with a material known to have lithium-selective ion exchange properties, such as those described in detail in prior art including U.S. Pat. No. 10,439,200 to Snydacker et al. Lithium-selective ion exchange materials are known to absorb lithium ions from liquids while releasing hydrogen ions, and the lithium ions are then eluted in acid to release hydrogen to the ion exchange materials. It is within the knowledge of a skilled person to select an appropriate ion exchange material given the brine feedstock and operating parameters. It is also known to use lithium-selective molecular sieve materials as an adsorbent.

While the details of the prior art methods vary, they commonly involve using a binder of some sort to increase the particle size of the adsorbent material to form larger particles or beads, applying the bound adsorbent material to a column of some kind, and flowing the brine through the column over the beads/particles. The brine is commonly then discarded (or recycled to extract further lithium or other valuable materials), water is flowed through the column to wash the material, and in some cases to strip the lithium. In other cases, another suitable stripping fluid is flowed through to desorb the lithium ions from the ion exchange material. The desorption fluid is collected, and water is flowed through for a second wash, and the entire process may then be repeated. The concentrated lithium ions may be sold in solution, or they may be recovered from the solution using known refining methods.

However, the prior art methods may manifest inefficiencies associated with the common recovery approach. First, the adsorbent material has the most uptake (mg Li per g ion exchange material) when unbound. Adding a binder to the adsorbent material blocks some of the reactive sites and thus reduces uptake. This undesirable loss of uptake is normally accepted because there is a struggle in practice to deal with the significant fraction of the adsorbent material that is very small, for one non-limiting example less than 1 micron in size. Without the binder, much of the unbound adsorbent material may be lost during processing using prior art methods. The bound adsorbent material is used in a column in order to prevent breakdown of these larger particles, which breakdown would otherwise happen if, for example, mechanical mixing was employed.

This reveals yet another disadvantage of some prior art methods. Using a column for adsorption/desorption does not effectively address the volume mismatch between lithium adsorption from the brine and desorption in the stripping fluid (which may, for non-limiting examples, be acid or water). The column must be sized to optimize either the adsorption process or the desorption process. Alternatively, a compromise column size can be used that fails to optimize either process.

Typically, 1 m³ of brine requires 3 to 10 kg of adsorbent material to extract the lithium. The volume mismatch means that either it takes an undesirably long time to run the brine through the column to get complete lithium uptake (which accordingly limits daily throughput), a large excess of adsorbent is loaded on the column (wasting lithium ion uptake capacity), or the brine flows over the column so quickly that only partial lithium extraction occurs (requiring a very large excess of water for complete lithium uptake). Desorption requires a much lower stripping fluid volume than brine. Minimizing the desorption fluid volume maximizes the lithium concentration after desorption. Higher lithium concentrations improve subsequent refining efficiency and lower overall production costs. However, using a column scaled to optimize adsorption will require larger desorption fluid volumes to successfully remove the lithium. Applying the adsorbent material to a column scaled to optimize desorption will lead to lower brine throughput or incomplete adsorption.

### SUMMARY

According to a first aspect of the present disclosure, there is provided a method for recovering target ions from a brine solution, the method comprising the steps of:
a. providing a brine solution comprising target ions;
b. providing a target-ion-selective adsorbent material;
c. mixing the brine solution and the target-ion-selective adsorbent material to form a slurry;
d. allowing at least some of the target ions in the slurry to bind with receptor sites on the target-ion-selective adsorbent material in the slurry, forming a processed slurry comprising target-ion-depleted brine and target-ion-enriched adsorbent material;
e. filtering the processed slurry to allow passage of the target-ion-depleted brine while retaining at least some of the target-ion-enriched adsorbent material;
f. removing at least some of the target ions from the target-ion-enriched adsorbent material using a desorption fluid to form a target-ion-depleted adsorbent material and a target-ion-concentrated solution; and
g. separating at least some of the target ions from the target-ion-concentrated solution.

The target-ion-selective adsorbent material may be in bound or unbound form. The target-ion-selective adsorbent material may be in particulate form. Further, the target-ion-selective adsorbent material may be an ion exchange material or a molecular sieve material.

In some exemplary embodiments of this first aspect, the target ions are lithium ions, the target-ion-selective adsorbent material is lithium-selective adsorbent material, the target-ion-depleted brine is lithium-depleted brine, the target-ion-enriched adsorbent material is lithium-enriched adsorbent material, the target-ion-depleted adsorbent material is lithium-depleted adsorbent material and the target-ion-concentrated solution is lithium-concentrated solution.

The target-ion-selective adsorbent material may be selected from a molecular sieve material and an ion exchange material.

The step of filtering may be achieved using one or more of a filter press, a candle filter, a vacuum belt filter, a disc filter, a drum filter, a centrifuge, a plate filter, a filter cloth and a membrane.

The desorption fluid is preferably water or an acid, although desorption for some target ions may involve other fluids that would be known to one skilled in the art.

Some exemplary methods further comprise the step before step c. of pre-treating the brine solution with one or more of air, ozone, and hydrogen sulfide scavengers. The pre-treating of the brine solution with the air may be achieved using one or more of an air flotation system, a skimmer, a compressor and tankage, in-line mixing, peroxide, and sodium hydroxide. Exemplary methods may also comprise the step before step c. of pre-filtering the brine solution with one or more of activated carbon, a nanopolymer dispersion, a walnut shell filter, and a bag filter.

In some exemplary embodiments, the step of mixing the brine solution and the target-ion-selective adsorbent material is achieved by one or more of forced air, mechanical mixers, and recirculating pumps.

Some exemplary methods further comprise the step after step e. of sending the target-ion-depleted brine to disposal or recycling the target-ion-depleted brine for subsequent target ion extraction.

Some exemplary methods further comprise the step after step e. and before step f. of rinsing the target-ion-enriched adsorbent material with wash water to remove residual free salts from the brine solution.

The step of filtering may comprise one filtering stage, or at least two filtering stages.

Some exemplary methods further comprise the step after step g. of recycling residual solution for use as a recycled desorption fluid for subsequent target ion extraction, and/or the step after step f. of rinsing the target-ion-depleted adsorbent material and reusing the rinsed target-ion-depleted adsorbent material for subsequent target ion extraction.

According to a second aspect of the present disclosure, there is provided a system for recovering target ions from a brine solution, the system comprising:
an adsorption vessel configured for mixing of the brine solution and a target-ion-selective adsorbent material to allow at least some of the target ions to bind with receptor sites on the target-ion-selective adsorbent material, forming a processed slurry comprising a target-ion-depleted brine and a target-ion-enriched adsorbent material;
a filtration device configured to allow passage of the target-ion-depleted brine while retaining at least some of the target-ion-enriched adsorbent material as a filter cake; and
a stripping fluid to desorb at least some of the target ions from the target-ion-enriched adsorbent material to form a target-ion-depleted adsorbent material and a target-ion-concentrated solution.

The target-ion-selective adsorbent material may be in bound or unbound form. The target-ion-selective adsorbent material may be in particulate form. Further, the target-ion-selective adsorbent material may be an ion exchange material or a molecular sieve material.

In some exemplary systems, the target ions are lithium ions, the target-ion-selective adsorbent material is lithium-selective adsorbent material, the target-ion-depleted brine is lithium-depleted brine, the target-ion-enriched adsorbent material is lithium-enriched adsorbent material, the target-ion-depleted adsorbent material is lithium-depleted adsorbent material and the target-ion-concentrated solution is lithium-concentrated solution.

The target-ion-selective adsorbent material may be selected from a molecular sieve material and an ion exchange material. The filtration device is preferably one or more of a filter press, a candle filter, a vacuum belt filter, a disc filter, a drum filter, a centrifuge, a plate filter, a filter cloth and a membrane. The stripping fluid is preferably water or an acid, although other fluids may be appropriate depending on the target ion.

Some exemplary systems pre-treat the brine solution with one or more of air, ozone, and hydrogen sulfide scavengers. Pre-treating of the brine solution with the air may be achieved using one or more of an air flotation system, a skimmer, a compressor and tankage, in-line mixing, peroxide, and sodium hydroxide. Exemplary systems may further comprise pre-filtering the brine solution with one or more of activated carbon, a nanopolymer dispersion, a walnut shell filter, and a bag filter.

The adsorption vessel may comprise one or more of forced air, mechanical mixers, and recirculating pumps.

Some exemplary systems further comprise a rinsing device for rinsing the target-ion-enriched adsorbent material with wash water to remove residual free salts from the brine solution.

The filtration device may comprise at least two filtration devices in series.

In some exemplary systems, the target-ion-selective adsorbent material is pre-coated with filter aids selected from the group consisting of diatomaceous earth, perlite, and other such materials that would be known to one skilled in the art. Alternatively, the filtration device may be pre-coated with filter aids selected from the group consisting of diatomaceous earth, perlite, and other such materials that would be known to one skilled in the art.

Desorption using an appropriate stripping fluid may occur on the filter cake in some exemplary embodiments.

A detailed description of exemplary embodiments of the present application is given in the following. It is to be understood, however, that the invention is not to be construed as being limited to these embodiments. The exemplary embodiments are directed to particular applications of the present application, while it will be clear to those skilled in the art that the present invention has applicability beyond the exemplary embodiments set forth herein.

### BRIEF DESCRIPTION OF THE DRAWINGS

The accompanying drawings illustrate exemplary embodiments of the present application.

FIG. 1 is a simplified schematic illustrating a first exemplary method and system according to the present invention.

FIG. 2 is a simplified schematic illustrating a second exemplary method and system according to the present invention.

FIG. 3 is a simplified schematic illustrating a third exemplary method and system according to the present invention.

Exemplary embodiments will now be described with reference to the accompanying drawings.

### DETAILED DESCRIPTION OF THE PREFERRED EMBODIMENTS

Throughout the following description, specific details are set forth in order to provide a more thorough understanding to persons skilled in the art. However, well known elements may not have been shown or described in detail to avoid unnecessarily obscuring the disclosure. The following description of examples of the invention is not intended to be exhaustive or to limit the invention to the precise form of any exemplary embodiment. Accordingly, the description and drawings are to be regarded in an illustrative, rather than a restrictive, sense.

In the following detailed description of exemplary embodiments, methods and systems for extracting lithium from brine are described. However, it will be clear that one skilled in the art would be able to determine other valuable components or species in a brine other than lithium to which the methods and systems described below could be applied to enable their extraction.

As used herein, “lithiated” means a material where lithium ions are adsorbed on at least one surface of the material.

The exemplary embodiments are directed to methods and systems for extracting or recovering lithium ions from a brine solution using a particulate lithium-selective adsorbent material. As noted above with respect to target-ion-selective adsorbent materials generally pursuant to the present invention, the lithium-selective adsorbent material can be in particulate form. Furthermore, the lithium-selective adsorbent material can be a molecular sieve material or an ion exchange material, but in the exemplary embodiments an ion exchange material is described. Specifically, an ion exchange material, which may be in bound form or unbound form, is used to maximize lithium uptake per gram of adsorbent. Eliminating the binder also reduces the overall cost of the ion exchange material. Rather than apply the ion exchange material to a column as in the prior art, embodiments according to the present invention involving mixing the ion exchange material with the brine in a large adsorption reactor/vessel/tank. Mixing the inputs in this way to form a slurry maximizes contact between the brine and the ion exchange material, thereby optimizing uptake efficiency and/or reducing reaction times.

Industrial filtration equipment (for non-limiting examples, filter presses, candle filters, belt filters, plate filters, etc.) are preferably used that can in some cases cases capture >99% of the ion exchange material (at 0.5 micron size) to separate it from the brine in the slurry. The filter cake that forms can then be washed and the lithium can be acid-desorbed before the ion exchange material is recycled back to the adsorption reactor. Washing and desorption may occur separately or on the filter equipment itself. In a significant advantage, working with the filter cake significantly reduces wash water and acid volumes (thereby improving efficiency). It is noted that performing all of the lithium extraction steps on the filter unit itself could be useful for high lithium concentration feed streams and/or with adsorbents having rapid kinetics.

Before turning to the Figures which illustrate the main stages of exemplary lithium extraction methods, it is noted that the brine feedstock may benefit from pre-treatment. When produced from the subsurface environment, the brine water may comprise contaminants that could interfere with the extraction process by interfering with the ability of the adsorbent to capture the lithium. These contaminants may include but are not limited to oil, solids, hydrogen sulfide and other potential species found in subsurface brines. The brine may also require pH adjustment.

In the case where little or no oil is produced with the brine, then the pre-treatment process preferably involves treating the brine with air, ozone, commercially available hydrogen sulfide scavengers, or any other water treatment agent that would be obvious to one skilled in the art. Aeration could be carried out using any air flotation system, skimmer, compressor and tankage, in-line mixing using static or other mixing devices, or other methods that would be obvious to one skilled in the art as being useful for the specific brine feedstock. Alternatively, peroxide, sodium hydroxide or other aqueous or solid reactants that would be obvious to one skilled in the art could be used. Pre-filtration with activated carbon, nanopolymer dispersion, walnut shell filter, bag filter or other media obvious to one skilled in the art could be used to prevent potential slugging of a small amount of oil from fouling the aeration system. In-line monitoring including but not limited to pH, conductivity, oxygen reduction potential and residual oil can be included as part of exemplary systems according to the present invention.

In the case where oil is being co-produced with the brine, then oil/brine separation will be carried out using standard oilfield techniques. Once the brine has been separated from the oil, the brine could go through the pre-treatment process described in the preceding paragraph.

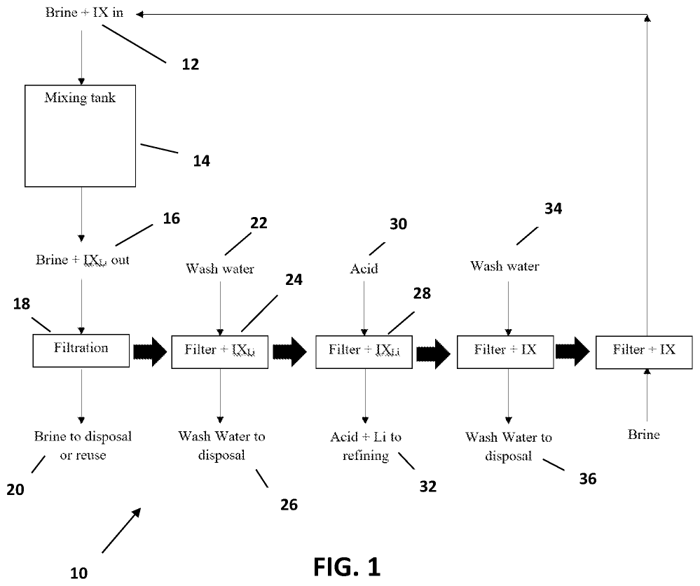

Turning now to FIG. 1, a first exemplary method and system is illustrated by the schematic labeled as 10. In the method and system 10, brine containing lithium ions and ion exchange material that absorbs lithium ions are combined into a slurry 12 and introduced into a mixing tank 14. While the slurry can be formed upstream of the mixing tank 14 as in the exemplary embodiment, the brine and ion exchange material can instead be slurried in the mixing tank. Mixing continues for a period of time (which may last from 5 min to 6 hours) appropriate to the process line-up and specific input specifications, as would be determinable by one skilled in the art. Mixing can be carried out using forced air, mechanical mixers, recirculating pumps or any other means that would be obvious to one skilled in the art. When lithium ion adsorption of the ion exchange material is determined to be sufficiently completed, which may be based on earlier developmental work supplemented by data on lithium uptake from prior cycles, the resultant output comprising lithium-depleted brine and lithiated ion exchange material 16 is pumped through a filter 18. The lithiated ion exchange material (IXLi) is held on the filter 18 in FIG. 1, while the spent brine 20 is sent as filtrate to disposal (although the spent brine 20 may be recycled for further processing if additional lithium or other valuable metals or materials remains to be extracted therefrom). Filtration can be performed using any number of known technologies, including for non-limiting examples a filter press, candle filter, vacuum belt filter, disc filter, plate filter, drum filter, centrifuge, or any other type of filter that would be obvious to one skilled in the art as being useful for the materials in question. Filter components can be used in any combination necessary to effect optimal capture of the lithiated ion exchange material. Filtrate 20 can be recycled to process lithiated ion exchange material that initially passes through the filter cloth or membrane 18 as the filter cake builds up. Filter aids including but not limited to diatomaceous earth or perlite can be used to pre-coat the filter cloth or membrane. Filter aids can also be combined directly with the ion exchange material prior to mixing with the brine to form the slurry 12.

Once the lithiated ion exchange material is on the filter 18, it can be washed in place with a first water wash 22 to remove any residual free salts left over from the brine feedstock, which may aid in downstream refining to remove the lithium from the acid solution. Alternatively, the filter cake can be blown, washed or scraped off or otherwise removed from the filter 18 and sent to the original mixing vessel 14 or a different mixing vessel (not shown). Water wash can then be carried out in the selected vessel. Mixing can again be carried out at this stage using forced air, mechanical mixers, recirculating pumps or any other means that would be obvious to one skilled in the art. The washed lithiated ion exchange material could be pumped against the original filter apparatus 18 or a secondary filter apparatus 24 where it would be captured as described above (although illustrated as using the second filter 24, it is to be understood that the first filter 18 could be used for this purpose). The first wash water 26 is sent for disposal.

This washed lithiated ion exchange material can then undergo acid desorption on the filter, illustrated as third filter 28, although it is to be understood that this could be either of the first two filters 18 or 24, using an acid 30 such as HCl although other acids would be selectable by the skilled person. Alternatively, the washed filter cake can be blown, washed or scraped off or otherwise removed from the filter 18 or 24, as the case may be, and sent to the original mixing vessel 14 or a different mixing vessel. The acid desorption desorbs the lithium ions of the lithiated ion exchange material where hydrogen ions in the acid solution replace the lithium ions in the lithiated ion exchange material. This lithium desorption process is the reverse of the adsorption process where the lithium ions in the brine are exchanged with hydrogen ions in the ion exchange material. The exchange process is pH dependent (i.e., driven by the hydrogen ion concentration). Lithium desorption could occur in this mixing vessel. Such mixing can be carried out using forced air, mechanical mixers, recirculating pumps or any other means that would be obvious to one skilled in the art. The resulting mixture of lithium/acid solution and lithium-depleted ion exchange material could then be applied to the filter 18, 24 or 28 where it would be filtered as described above. The lithium/acid filtrate 32 would be collected and stored for refining. The acid could be recycled a number of times to systematically increase the lithium concentration. The acid solution has a much higher lithium exchange capacity than the amount of lithium present in one adsorption cycle; as such, the same acid solution can be used for multiple desorptions, and the lithium concentration will increase in the acid after each cycle it is used. The higher concentration of lithium in the acid may make the refining process more efficient.

Once the lithium-depleted ion exchange material is on the filter 18, 24 or 28 after desorption, it can be washed in place with water 34. Alternatively, the filter cake of lithium-depleted ion exchange material can be blown, washed or scraped off or otherwise removed from the filter 18, 24 or 28 and sent to the original mixing vessel 14 or a different mixing vessel. The second water wash 34 can then be carried out in the mixing vessel. Mixing can be carried out using forced air, mechanical mixers, recirculating pumps or any other means that would be obvious to one skilled in the art, and the washed lithium-depleted ion exchange material could then be applied to the filter 18, 24 or 28 for filtration as described above, with the second wash water sent for disposal at 36 or retained to make subsequent batches of desorption acid to ensure the capture of any residual lithium in the wash. The washed lithium-depleted ion exchange material filter cake can be blown, washed or scraped off or otherwise removed from the filter 18, 24 or 28. It can then be mixed with fresh brine and the next cycle can begin, or the washed, lithium-depleted ion exchange material could also be washed off directly with brine.

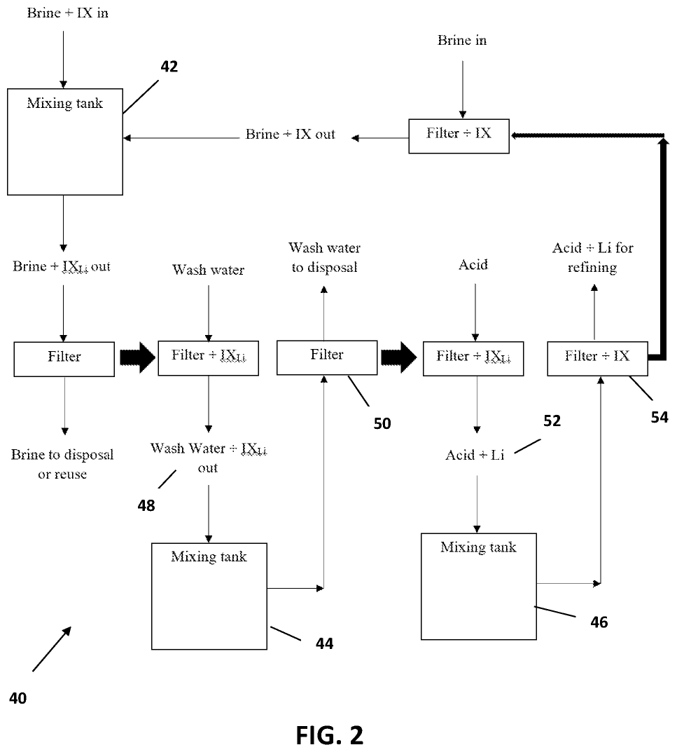

Turning now to FIG. 2, a second exemplary embodiment is illustrated. In this embodiment, a system/method 40 is illustrated that is similar in many respects to FIG. 1, but with three mixing tanks 42, 44 and 46. Mixing tank 42 operates in a manner akin to mixing tank 14 described above, while mixing tank 44 receives the slurry 48 of first wash water and lithiated ion exchange material and mixes same before sending the mixture to filter 50. Mixing tank 46 receives the lithium/acid solution 52 from the desorption stage and mixes same before sending the mixture to filter 54, as the ion exchange material isn't in a cake so the mixing may improve mass transport and speed up the extraction, before a final filtering of the filtrate (lithium-depleted ion exchange material) for re-use in the mixing tank 42.

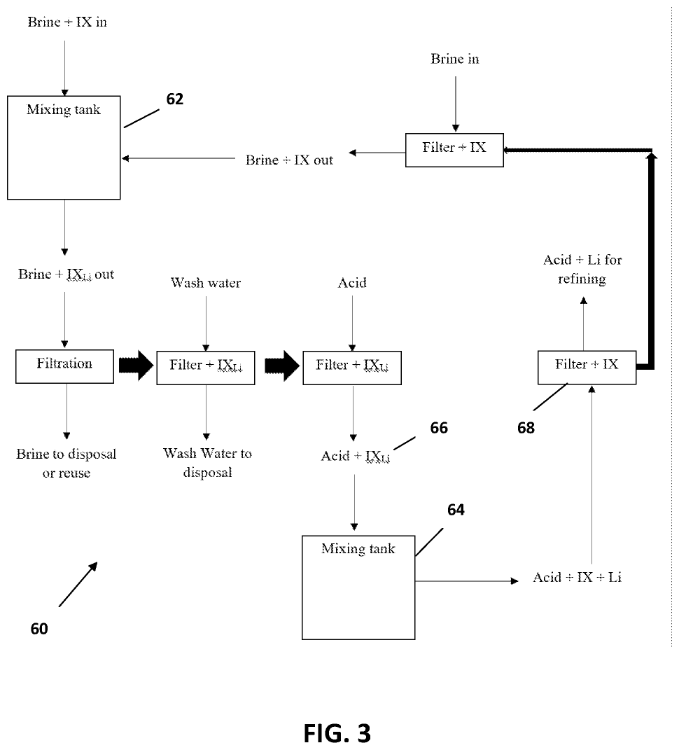

Turning now to FIG. 3, a third exemplary embodiment is illustrated. In this embodiment, a system/method 60 is illustrated wherein two mixing tanks 62, 64 are employed. Mixing tank 62 operates in a manner akin to mixing tank 14 described above, while mixing tank 64 receives the lithium/acid solution 66 from the desorption stage and mixes same before sending the mixture to filter 68, before a final filtering of the filtrate (lithium-depleted ion exchange material) for re-use in the mixing tank 62.

### EXAMPLE

To demonstrate the present invention, an exemplary embodiment for lithium extraction was conducted at lab scale using a commercially available Buon Vino Mini Jet filter press from Buon Vino Manufacturing Incorporated. In this exemplary extraction, every step of the lithium extraction was carried out on the filter press, although alternative examples could have involved carrying out adsorption before the ion extraction material was applied to the filter press.

The adsorbent was suspended in water and applied to the filter cartridges by circulating this suspension through the filter press. Adsorption was carried out using 500 mL of brine from a water well, the brine having a salinity of greater than 200,000 ppm TDS, pH of 6.5, and lithium concentration at 65 ppm. 4 g of the lithium-selective ion exchange material Li_{1.33}Mn_{1.67}O₄ was used. The pH of the brine was maintained at 6.5 during adsorption using NaOH. Adsorption was carried out by recirculating the brine through the filter press for 1 hour. The brine temperature was maintained at 60 C using a standard laboratory hot plate to approximate the typical temperature of water coming out of the wellhead. Wash after desorption was carried out by pumping treated municipal water through the filter press for 2 to 5 minutes. Desorption was carried out at room temperature using 200 mL of 1 Normal hydrochloric acid. The acid was recirculated through the filter press for 30 minutes. Wash after desorption was carried out using treated municipal water for 2 to 5 minutes. The following results were obtained using the filter press:
1. Complete retention of the ion exchange medium on the filter press (no adsorbent passing through the filter).
2. 97% lithium uptake from the brine during the adsorption phase as determined by ICP-MS analysis of the brine before and after adsorption.
3. Approximately 30% recovery of the lithium ions during the extraction phase as determined by ICP-MS analysis of the acid.

The foregoing is considered as illustrative only of the principles of the present invention. The scope of the claims should not be limited by the exemplary embodiments set forth in the foregoing, but should be given the broadest interpretation consistent with the specification as a whole.

What is claimed is:

1. A method for recovering target ions from a brine solution, the method comprising the steps of:
a. providing a brine solution comprising target ions;
b. providing a target-ion-selective adsorbent material;
c. mixing the brine solution and the target-ion-selective adsorbent material to form a slurry;
d. allowing at least some of the target ions in the slurry to bind with receptor sites on the target-ion-selective adsorbent material in the slurry, forming a processed slurry comprising target-ion-depleted brine and target-ion-enriched adsorbent material;
e. filtering the processed slurry to allow passage of the target-ion-depleted brine while retaining at least some of the target-ion-enriched adsorbent material;
f. removing at least some of the target ions from the target-ion-enriched adsorbent material using a desorption fluid to form a target-ion-depleted adsorbent material and a target-ion-concentrated solution; and
g. separating at least some of the target ions from the target-ion-concentrated solution.

2. The method of claim 1 wherein the target ions are lithium ions, the target-ion-selective adsorbent material is lithium-selective adsorbent material, the target-ion-depleted brine is lithium-depleted brine, the target-ion-enriched adsorbent material is lithium-enriched adsorbent material, the target-ion-depleted adsorbent material is lithium-depleted adsorbent material and the target-ion-concentrated solution is lithium-concentrated solution.

3. The method of claim 1 wherein the target-ion-selective adsorbent material is selected from a molecular sieve material and an ion exchange material.

4. The method of claim 1 wherein the step of filtering is achieved using one or more of a filter press, a candle filter, a vacuum belt filter, a disc filter, a drum filter, a centrifuge, a plate filter, a filter cloth and a membrane.

5. The method of claim 1 wherein the desorption fluid is water or an acid.

6. The method of claim 1 further comprising the step before step c. of pre-treating the brine solution with one or more of air, ozone, and hydrogen sulfide scavengers.

7. The method of claim 6 wherein the pre-treating of the brine solution with the air is achieved using one or more of an air flotation system, a skimmer, a compressor and tankage, in-line mixing, peroxide, and sodium hydroxide.

8. The method of claim 1 comprising the step before step c. of pre-filtering the brine solution with one or more of activated carbon, a nanopolymer dispersion, a walnut shell filter, and a bag filter.

9. The method of claim 1 wherein the step of mixing the brine solution and the target-ion-selective adsorbent material is achieved by one or more of forced air, mechanical mixers, and recirculating pumps.

10. The method of claim 1 further comprising the step after step e. of sending the target-ion-depleted brine to disposal or recycling the target-ion-depleted brine for subsequent target ion extraction.

11. The method of claim 1 further comprising the step after step e. and before step f of rinsing the target-ion-enriched adsorbent material with wash water to remove residual free salts from the brine solution.

12. The method of claim 1 wherein the step of filtering comprises at least two filtering stages.

13. The method of claim 1 further comprising the step after step g. of recycling residual solution for use as a recycled desorption fluid for subsequent target ion extraction.

14. The method of claim 1 further comprising the step after step f. of rinsing the target-ion-depleted adsorbent material and reusing the rinsed target-ion-depleted adsorbent material for subsequent target ion extraction.

15. A system for recovering target ions from a brine solution, the system comprising:
an adsorption vessel configured for mixing of the brine solution and a target-ion-selective adsorbent material to allow at least some of the target ions to bind with receptor sites on the target-ion-selective adsorbent material, forming a processed slurry comprising target-ion-depleted brine and a target-ion-enriched adsorbent material;
a filtration device, the filtration device configured to allow passage of the target-ion-depleted brine while retaining at least some of the target-ion-enriched adsorbent material as a filter cake; and
a stripping fluid to desorb at least some of the target ions from the target-ion-enriched adsorbent material to form a target-ion-depleted adsorbent material and a target-ion-concentrated solution.

16. The system of claim 15 wherein the target ions are lithium ions, the target-ion-selective adsorbent material is lithium-selective adsorbent material, the target-ion-depleted brine is lithium-depleted brine, the target-ion-enriched adsorbent material is lithium-enriched adsorbent material, the target-ion-depleted adsorbent material is lithium-depleted adsorbent material and the target-ion-concentrated solution is lithium-concentrated solution.

17. The system of claim 15 wherein the target-ion-selective adsorbent material is selected from a molecular sieve material and an ion exchange material.

18. The system of claim 15 wherein the filtration device is one or more of a filter press, a candle filter, a vacuum belt filter, a disc filter, a drum filter, a centrifuge, a plate filter, a filter cloth and a membrane.

19. The system of claim 15 wherein the stripping fluid is water or an acid.

20. The system of claim 15 further comprising pre-treating the brine solution with one or more of air, ozone, and hydrogen sulfide scavengers.

21. The system of claim 20 wherein the pre-treating of the brine solution with the air is achieved using one or more of an air flotation system, a skimmer, a compressor and tankage, in-line mixing, peroxide, and sodium hydroxide.

22. The system of claim 15 further comprising pre-filtering the brine solution with one or more of activated carbon, a nanopolymer dispersion, a walnut shell filter, and a bag filter.

23. The system of claim 15 wherein the adsorption vessel comprises one or more of forced air, mechanical mixers, and recirculating pumps.

24. The system of claim 15 further comprising a rinsing device for rinsing the target-ion-enriched adsorbent material with wash water to remove residual free salts from the brine solution.

25. The system of claim 15 wherein the filtration device comprises at least two filtration devices in series.

26. The system of claim 15 wherein the target-ion-selective adsorbent material is pre-coated with filter aids selected from the group consisting of diatomaceous earth and perlite.

27. The system of claim 15 wherein the filtration device is pre-coated with filter aids selected from the group consisting of diatomaceous earth and perlite.

28. The system of claim 15 wherein the stripping fluid desorbing occurs on the filter cake.

29. The system of claim 24 wherein the rinsing device is configured for rinsing the target-ion-enhanced adsorbent material while on the filtration device as the filter cake.
